(19) United States
(12) Patent Application Publication
(10) Pub. No.: US 2008/0299277 A1
(43) Pub. Date: Dec. 4, 2008

(54) Sweetening Compositions

(76) Inventors: Yaohai Chao, Edison, NJ (US); Xiaojian Ye, North Brunswick, NJ (US); Hui Zhang, Branchburg, NJ (US)

Correspondence Address: FISH & RICHARDSON P.C., P.O. BOX 1022, MINNEAPOLIS, MN, 55440-1022, US

(21) Appl. No.: 12/130,343

(22) Filed: May 30, 2008

Related U.S. Application Data
(60) Provisional application No. 60/941,585, filed on Jun. 1, 2007.

(51) Int. Cl. A23L 1/236; A23L 1/09

(52) U.S. Cl. 426/548; 426/658

(57) ABSTRACT

This disclosure relates to sweetening compositions that include (1) at least a sweetener selected from the group consisting of sucralose, acesulfame potassium, saccharin, aspartame, a stevia extract, neotame, cyclamate, a Luo Han Guo extract, a polyol, and a mixture thereof; (2) at least a preservative selected from the group consisting of potassium sorbate, sodium sorbate, sodium benzoate, potassium benzoate, methyl gallate, propyl gallate, sodium ethylenediaminetetraacetate, methyl paraben, propyl paraben, and a mixture thereof; and (3) at least an acid selected from the group consisting of citric acid, succinic acid, lactic acid, propionic acid, tartaric acid, tannic acid, phosphoric acid, adipic acid, malic acid, acetic acid, gluconic acid, ascorbic acid, and a mixture thereof.

### CROSS REFERENCE TO RELATED APPLICATION

This application claims priority under 35 U.S.C. §119(e) to U.S. Provisional Application Ser. No. 60/941,585, filed Jun. 1, 2007, the contents of which are incorporated herein by reference.

### BACKGROUND

Sucrose, commonly known as table sugar, has been used broadly as a sweetener due to its sweetness strength and good quality. However, since sucrose has relatively high calories, much effort has been directed to develop alternative sweeteners for diabetic or overweight patients.

Sucralose has recently attracted much attention as a sucrose alternative because it is not metabolizable in human body, does not produce any calorie, and is about 600 times sweeter than sucrose. Sucralose is generally stable under the normal room and warehouse conditions when it is present in a low amount in food or other products. However, discoloration and hydrolysis can happen over time when the sucralose is in a high concentration (either in a dry or liquid form) or exposed to a high temperature. Thus, it remains desirable to prepare sucralose in a more stable form for long term storage under the high temperature or high concentration conditions.

### SUMMARY

In general, the disclosure relates to sweetening compositions.

In one aspect, the disclosure features a composition that includes a sweetener selected from the group consisting of sucralose, acesulfame potassium, saccharin, aspartame, a stevia extract, neotame, cyclamate, a Luo Han Guo extract, a polyol, and a mixture thereof; a preservative; and an acid. The composition does not include a pH buffer. The sweetener can range from about 0.5% to about 30% of the total weight of the composition. The preservative can range from about 0.01% to about 3% of the total weight of the composition. Examples of the preservatives include potassium sorbate, sodium sorbate, sodium benzoate, potassium benzoate, methyl gallate, propyl gallate, sodium ethylenediaminetetraacetate, methyl paraben, propyl paraben, or a mixture thereof. The acid can range from about 0.01% to about 3% of the total weight of the composition. Examples of the acid include citric acid, succinic acid, lactic acid, propionic acid, tartaric acid, tannic acid, phosphoric acid, adipic acid, malic acid, acetic acid, gluconic acid, ascorbic acid, or a mixture thereof.

The above composition can further include a solvent selected from the group consisting of water, ethanol, glycerin, a polyethylene glycol, a polysorbate, and a mixture thereof. The solvent can range from about 70% to about 99.5% of the total weight of the composition. The above composition can have a pH of at most about 5 (e.g., at most about 4) or at least about 3 (e.g., at least about 3.5).

In another aspect, the disclosure features a composition that consists of a sweetener selected from the group consisting of sucralose, acesulfame potassium, saccharin, aspartame, a stevia extract, neotame, cyclamate, a Luo Han Guo extract, a polyol, or a mixture thereof; a preservative; an acid; and a solvent. The preservative, acid and solvent can be the same as those described above.

In another aspect, the disclosure features a composition that includes sucralose; a second sweetener selected from the group consisting of a Luo Han Guo extract, a polyol, and a mixture thereof; one of the preservatives described above; and one of the acids described above. The second sweetener can range from about 10% to about 20% of the total weight of the composition. The weight ratio between the sucralose and the second sweetener can range from about 1:2 to about 1:40.

In another aspect, the disclosure features a composition that includes one of the sweeteners described above; one of the preservatives described above; and succinic acid. This composition can further include a second acid selected from the group consisting of citric acid, lactic acid, propionic acid, tartaric acid, tannic acid, phosphoric acid, adipic acid, malic acid, acetic acid, gluconic acid, ascorbic acid, and a mixture thereof. The weight ratio between the succinic acid and the second acid can range from about 1:2 to about 2:1.

In still another aspect, the disclosure features a composition that includes sucralose, one of the preservatives described above, a first acid selected from one of the acids described above, and a second acid selected from one of the acids described above, the second acid being different from the first acid.

The details of one or more embodiments of the invention are set forth in the description below. Other features and advantages of the invention will be apparent from the description and the claims.

### DETAILED DESCRIPTION

This disclosure generally relates to sweetening compositions that include at least a sweetener, at least a preservative, and at least an acid.

Sucralose is a high intensity sweetener and can be used in the sweetening compositions described above. When sucralose is the only sweetener used in the sweetening compositions described above, the compositions can include a high amount of sucralose. For example, the amount of sucralose can range from about 0.5% to about 30% (e.g., from about 1% to about 25%, from about 5% to about 20%, or from about 10% to about 15%) of the total weight of the compositions at room temperature when water is used as a solvent. The sucralose concentration can vary within this range depending on the desired sweetness. To avoid any sucralose crystallization from water during use of the sweetening compositions, the sucralose is preferably not more than 25% of the total weight of the compositions. If a higher sucralose amount is required, a water-miscible organic solvent (e.g., propylene glycol or glycerin) can be added or in place of water to increase the solubility of sucralose.

Sucralose can also be used in combination with other sweeteners that are sucrose alternatives. One group of such sweeteners are known as high intensity sweeteners, which are much sweeter than sucrose. Examples of high intensity sweeteners include sucralose, acesulfame potassium, saccharin, aspartame, a stevia extract (e.g., steviol glycosides), neotame, cyclamate, and a Luo Han Guo extract (e.g., Luo Han Guo mogrosides). Another group of such sweeteners are polyols, such as sugar alcohols (e.g., erythritol, sorbitol, mannitol, maltitol, palatinose, lactitol, xylitol, arabitol, glycerol, isomalt, galactitol, or ribitol). This group of sweeteners are typically not sweeter than sucrose. As used herein, the sweeteners described above also include their suitable salts. Without wishing to be bound by theory, it is believed that a combination of sucralose and one or more sweeteners mentioned above (e.g., a Luo Han Guo extract or erythritol) can result in synergistic effects. For example, such a combination can result in compositions that are noticeably sweeter than what would have been predicted on a simple additive basis from the sweetening strength of the individual sweeteners.

When sucralose is used in combination with other sweeteners, the amounts of the sucralose and other sweeteners can vary as desired to achieve the optimized sweetness synergy. For example, when sucralose is used together with a second high intensity sweetener (e.g., acesulfame potassium, saccharin, aspartame, a stevia extract, neotame, cyclamate, or a Luo Han Guo extract), the amount of sucralose can range from about 70% to about 99.5% of the total weight of the sweeteners and the amount of the second sweetener can range from about 0.5% to about 30% of the total weight of the sweeteners to achieve the optimized sweetness synergy. As another example, when sucralose is used together with a polyol (e.g., a sugar alcohol), the amount of sucralose can range from about 0.5% to about 30% of the total weight of the sweeteners and the amount of the polyol can range from about 70% to about 99.5% of the total weight of the sweeteners to achieve the optimized sweetness synergy.

If desired, sucralose can be used together with two or more additional sweeteners (e.g., a polyol and a second high intensity sweetener). To achieve optimal sweetness synergy, the amount ratio between sucralose and a second high intensity sweetener and the amount ratio between sucralose and a polyol can be within the same ranges described in the preceding paragraph above.

The preservative in the compositions described above is well known in the art and is generally used to provide antimicrobial properties so that the compositions can remain stable during long term storage. Exemplary preservative include potassium sorbate, sodium sorbate, sodium benzoate, potassium benzoate, methyl gallate, propyl gallate, sodium ethylenediaminetetraacetate, methyl paraben, propyl paraben, and a mixture thereof. The amount of the preservative can range from about 0.01 to about 3.0% of the total weight of the compositions. For example, the amount can range from 0.1% to about 2% or from about 0.5% to about 1% of the total weight of the compositions. In one example, when the preservative includes a mixture of potassium sorbate and sodium benzoate, the weight ratio of these two compounds can range from about 2:1 to about 1:2.

The acid in the compositions described above is generally used to provide an acidic condition necessary for the preservative to stabilize the sweetener (e.g., sucralose). The acid can also function as a flavor modifier to reduce aftertastes. Exemplary acids include weak acids such as citric acid, succinic acid, lactic acid, propionic acid, tartaric acid, tannic acid, phosphoric acid, adipic acid, malic acid, acetic acid, gluconic acid, ascorbic acid, and a mixture of these acids. The amount of the acid can range from about 0.01% to about 3.0% of the total weight of the compositions. For example, the amount can range from 0.1% to about 2% or from about 0.5% to about 1% of the total weight of the compositions.

The sweetening compositions described above can also include two or more acids (e.g., a mixture of citric acid and succinic acid or a mixture of citric acid and malic acid). For example, the compositions can include succinic acid and an additional acid (e.g., citric acid). Without wishing to be bound by theory, it is believed that an advantage of using succinic acid is that it can significantly enhance the taste profile of the sweetening compositions described above. Specifically, it is believed that succinic acid brings to the sweetening compositions described above a unique taste, which is a combination of the distinctive saltiness and acidity. This unique taste could significantly offset the sweet aftertaste resulted from sucralose and improve the rich mouth-feeling of the compositions. Preferably, the weight ratio between the two acids can range from about 1:2 to about 2:1 (e.g., about 1:1).

The sweetening compositions described above can further include a solvent, such as water or a water-miscible organic solvent. Typically, the solvent is at least food grade when the final compositions are intended for food products and at least United States Pharmacopeia (USP) grade when the final compositions are intended for pharmaceutical products.

If desired, certain water-miscible organic solvents can be added to replace a portion of water or to replace water entirely in the final sweetening compositions. Examples of such solvents include ethanol, glycerin, a polyethylene glycol (PEG), a polysorbate (e.g., polysorbate 80), and a mixture thereof. The addition of such solvents can improve the sucralose solubility and enhance the heat resistance, flow properties, viscosity, and other properties of the sweetening compositions to satisfy special manufacturing needs. The water-miscible organic solvents are typically at least food grade except that ethanol is typically at least USP grade.

The pH of the sweetening compositions described above is not particularly controlled as long as it allows the preservative to function properly. Preferably, the pH is at least about 3 (e.g., at least about 3.5) or at most about 5 (e.g., at most about 4).

The sweetening compositions described above do not include a pH buffer. As used herein, the term “pH buffer” refers to a composition that can effectively maintain the pH value. Typically, the pH buffer includes two components (e.g., a weak acid and a salt of the acid or two weak acid salts). For example, when citric acid is used, the sweetening compositions described above are not prepared by mixing a mixture of citric acid and a citrate salt (e.g., sodium citrate) with other components to form a pH buffer to maintain the pH of the final compositions. Even though there might be a very small amount of a citrate salt formed in the sweetening compositions described above (e.g., due to the presence of a small amount of citrate anion formed from the citric acid and the metal cation formed from the preservative (e.g., sodium benzoate)), the amount of the citrate salt would not be sufficient to form an effective pH buffer. Without wishing to be bound by theory, it is believed that an advantage of not using a pH buffer in the sweetening compositions describe above is removal of unpleasant tastes resulted from the pH buffer (e.g., from a citrate salt in the pH buffer) and improvement of taste characteristics (e.g., initial sweet burst, sweet persistence, bitter, bitter aftertaste, or smoothness), while the stability of the compositions (e.g., in terms of discoloration and hydrolysis) is maintained (e.g., similar to that of the compositions including a pH buffer).

The sweetening compositions described above can be made by methods well known in the art and methods described herein. For examples, they can be prepared by mixing suitable amounts of at least a sweetener (e.g., sucralose), at least a preservative (e.g., sodium benzoate), and at least an acid (e.g., succinic acid) in at least a solvent (e.g., water) to form desired compositions.

The sweetening compositions described above can be used in dry form (e.g., as powder or tablet) or in aqueous form (e.g., in beverage or syrup). When the sweetening compositions are used in powder, the powder can be used conveniently to prepare beverages (e.g., tea or juice), paste, jelly, capsules, or tablets. Lactose and corn starch are commonly used as diluents for capsules and as carriers for tablets. Lubricating agents, such as magnesium stearate, are also typically added to form tablets. The sweetening compositions can also be used in a dietary supplement or a pharmaceutical formulation. As a dietary supplement, additional nutrients, such as minerals or amino acids may be included. Further, the sweetening compositions can be used in a drink or a food product. Exemplary drinks or food products include tea (e.g., a tea drink or the contents of a tea bag), soft drinks, juice (e.g., a fruit extract or a juice drink), milk, coffee, cookies, cereals, chocolates, and snack bars. In addition, the sweetening compositions can be used as a table sweeteners as a replacement for sucrose. If desired, the sweetening compositions can be diluted to the sweetness level desired in the uses described above. The dilution can be accomplished by, for example, adding purified water to the sweetening compositions at the desired level.

The following examples are illustrative and not intended to be limiting.

### EXAMPLES

It is to be understood that, in the following examples, all parts and % means parts by weight and % by weight, respectively, and that unless otherwise indicated, the amounts of ingredients are expressed in parts by weight.

A typical process used for preparing a sweetening composition is described below:

1) A predetermined amount of purified water is weighed and added to a stainless steel tank of a suitable size equipped with a stirring apparatus and a heating/cooling system.

2) After the purified water is heated to about 40° C., predetermined amounts of sucralose and/or other sweeteners are added while stirring.

3) Predetermined amounts of at least a preservative and at least an acid are added while the stirring is continued and the temperature is maintained at 40° C.

4) The stirring is continued for fifteen minutes or until sucralose and/or other sweeteners are dissolved while the temperature is maintained at 40° C.

5) After the resultant mixture is filtered through a 0.45 μm filter, and the filtrate is collected into a suitable container.

### Example 1

A concentrated sucralose-containing sweetening aqueous composition was prepared according to the procedure described above and had the following formulation:

| Ingredient | Weight % |
|---|---|
| Purified Water | 74.5 |
| Sucralose | 25.0 |
| Sodium Benzoate | 0.15 |
| Potassium Sorbate | 0.15 |
| Citric acid (anhydrous) | 0.1 |
| Succinic Acid | 0.1 |

The composition was an acidic, clear, colorless solution and demonstrated excellent stability in both room temperature and elevated temperature conditions.

### Example 2

A concentrated sucralose-containing sweetening aqueous composition was prepared according to the procedure described above and had the following formulation:

| Ingredient | Weight % |
|---|---|
| Purified Water | 74.5 |
| Sucralose | 25.0 |
| Sodium Ethylene Diaminetetraacetate | 0.15 |
| Potassium Sorbate | 0.15 |
| Citric acid (anhydrous) | 0.2 |

The composition was an acidic, clear, colorless solution and demonstrated excellent stability in both room temperature and elevated temperature conditions.

### Example 3

A concentrated sucralose-containing sweetening aqueous composition was prepared according to the procedure described above and had the following formulation:

| Ingredient | Weight % |
|---|---|
| Purified Water | 74.5 |
| Sucralose | 25.0 |
| Sodium Ethylene Diaminetetraacetate | 0.2 |
| Potassium Sorbate | 0.15 |
| Citric Acid (anhydrous) | 0.2 |

The composition was an acidic, clear, colorless solution and demonstrated excellent stability in both room temperature and elevated temperature conditions.

### Example 4

A concentrated sucralose-containing sweetening aqueous composition was prepared according to the procedure described above and had the following formulation:

| Ingredient | Weight % |
|---|---|
| Purified Water | 74.4 |
| Sucralose | 25.0 |
| Sodium Benzoate | 0.25 |
| Potassium Sorbate | 0.15 |
| Succinic Acid | 0.2 |

The composition was an acidic, clear, colorless solution and demonstrated excellent stability in both room temperature and elevated temperature conditions.

### Example 5

A concentrated sucralose-containing sweetening aqueous composition was prepared according to the procedure described above and had the following formulation:

| Ingredient | Weight % |
|---|---|
| Purified Water | 82.45 |
| Sucralose | 2.0 |
| Luo Han Guo Extract | 15.0 |
| Sodium Benzoate | 0.2 |
| Potassium Sorbate | 0.15 |
| Citric Acid (anhydrous) | 0.1 |
| Malic Acid | 0.1 |

The composition was an acidic, clear, colorless solution and demonstrated excellent stability in both room temperature and elevated temperature conditions.

### Example 6

A concentrated sucralose-containing sweetening aqueous composition was prepared according to the procedure described above and had the following formulation:

| Ingredient | Weight % |
|---|---|
| Purified Water | 77.4 |
| Sucralose | 2 |
| Erythritol | 20 |
| Sodium Ethylene Diaminetetraacetate | 0.15 |
| Potassium Sorbate | 0.15 |
| Citric Acid (anhydrous) | 0.15 |
| Propionic Acid | 0.15 |

The composition was an acidic, clear, colorless solution and demonstrated excellent stability in both room temperature and elevated temperature conditions.

### Example 7

A concentrated sucralose-containing sweetening aqueous composition was prepared according to the procedure described above and had the following formulation:

| Ingredient | Weight % |
|---|---|
| Purified Water | 76.5 |
| Sucralose | 5.0 |
| Stevia Extract | 10.0 |
| Sodium Benzoate | 0.15 |
| Potassium Sorbate | 0.15 |
| Succinic Acid | 0.1 |
| Malic Acid | 0.1 |

The composition was an acidic, clear, colorless solution and demonstrated excellent stability in both room temperature and elevated temperature conditions.

### Example 8

A concentrated sucralose-containing sweetening aqueous composition was prepared according to the procedure described above and had the following formulation:

| Ingredient | Weight % |
|---|---|
| Purified Water | 77 |
| Sucralose | 22.5 |
| Methyl Gallate | 0.05 |
| Propyl Paraben | 0.05 |
| Sodium Benzoate | 0.2 |
| Citric Acid (anhydrous) | 0.1 |
| Malic Acid | 0.1 |

The composition was an acidic, clear, colorless solution and demonstrated excellent stability in both room temperature and elevated temperature conditions.

### Example 9

A concentrated sucralose-containing sweetening aqueous composition was prepared according to the procedure described above and had the following formulation:

| Ingredient | Weight % |
|---|---|
| Purified Water | 74.5 |
| Sucralose | 25.0 |
| Methyl Gallate | 0.05 |
| Propyl Paraben | 0.05 |
| Sodium Benzoate | 0.2 |
| Citric Acid (anhydrous) | 0.1 |
| Malic Acid | 0.1 |

The composition was an acidic, clear, colorless solution and demonstrated excellent stability in both room temperature and elevated temperature conditions.

### Example 10

A concentrated sucralose-containing sweetening aqueous composition was prepared according to the procedure described above and had the following formulation:

| Ingredient | Weight % |
|---|---|
| Purified Water | 79.64 |
| Sucralose | 20.0 |
| Propyl Paraben | 0.05 |
| Sodium Benzoate | 0.3 |
| Phosphoric Acid (85%) | 0.01 |

The composition was an acidic, clear, colorless solution and demonstrated excellent stability in both room temperature and elevated temperature conditions.

### Example 11

A concentrated sucralose-containing sweetening aqueous composition was prepared according to the procedure described above and had the following formulation:

| Ingredient | Weight % |
|---|---|
| Purified Water | 86.2 |
| Sucralose | 5.0 |
| Flavors & Colors Additives | 8.0 |
| Sodium Benzoate | 0.25 |
| Potassium Sorbate | 0.15 |
| Citric Acid (anhydrous) | 0.2 |
| Malic Acid | 0.2 |

The composition was an acidic, clear, colorless solution and demonstrated excellent stability in both room temperature and elevated temperature conditions.

Other embodiments are in the claims.

What is claimed is:

1. A composition, comprising:
a sweetener selected from the group consisting of sucralose, acesulfame potassium, saccharin, aspartame, a stevia extract, neotame, cyclamate, a Luo Han Guo extract, a polyol, and a mixture thereof;
a preservative; and
an acid;
wherein the composition does not include a pH buffer.

2. The composition of claim 1, wherein the preservative is potassium sorbate, sodium sorbate, sodium benzoate, potassium benzoate, methyl gallate, propyl gallate, sodium ethylenediaminetetraacetate, methyl paraben, propyl paraben, or a mixture thereof.

3. The composition of claim 1, wherein the acid is citric acid, succinic acid, lactic acid, propionic acid, tartaric acid, tannic acid, phosphoric acid, adipic acid, malic acid, acetic acid, gluconic acid, ascorbic acid, or a mixture thereof.

4. The composition of claim 1, further comprising a solvent selected from the group consisting of water, ethanol, glycerin, a polyethylene glycol, a polysorbate, and a mixture thereof.

5. The composition of claim 4, wherein the solvent is about 70% to about 99.5% of the total weight of the composition.

6. The composition of claim 1, wherein the sweetener is about 0.5% to about 30% of the total weight of the composition.

7. The composition of claim 1, wherein the preservative is about 0.01% to about 3% of the total weight of the composition.

8. The composition of claim 1, wherein the acid is about 0.01% to about 3% of the total weight of the composition.

9. The composition of claim 1, wherein the composition has a pH at most about 5.

10. The composition of claim 1, wherein the composition has a pH at most about 4.

11. The composition of claim 1, wherein the composition has a pH at least about 3.

12. A composition, consisting of:
a sweetener selected from the group consisting of sucralose, acesulfame potassium, saccharin, aspartame, a stevia extract, neotame, cyclamate, a Luo Han Guo extract, a polyol, or a mixture thereof;
a preservative;
an acid; and
a solvent.

13. The composition of claim 12, wherein the preservative is potassium sorbate, sodium sorbate, sodium benzoate, potassium benzoate, methyl gallate, propyl gallate, sodium ethylenediaminetetraacetate, methyl paraben, propyl paraben, or a mixture thereof.

14. The composition of claim 12, wherein the acid is citric acid, succinic acid, lactic acid, propionic acid, tartaric acid, tannic acid, phosphoric acid, adipic acid, malic acid, acetic acid, gluconic acid, ascorbic acid, or a mixture thereof.

15. The composition of claim 12, wherein the solvent is selected from the group consisting of water, ethanol, glycerin, a polyethylene glycol, a polysorbate, and a mixture thereof.

16. The composition of claim 12, wherein the solvent is about 70% to about 99.5% of the total weight of the composition.

17. The composition of claim 12, wherein the sweetener is about 0.5% to about 30% of the total weight of the composition.

18. The composition of claim 12, wherein the preservative is about 0.01% to about 3% of the total weight of the composition.

19. The composition of claim 12, wherein the acid is about 0.01% to about 3% of the total weight of the composition.

20. The composition of claim 12, wherein the composition has a pH at most about 5.

21. The composition of claim 12, wherein the composition has a pH at most about 4.

22. The composition of claim 12, wherein the composition has a pH at least about 3.

23. A composition, comprising:
sucralose;
a second sweetener selected from the group consisting of a Luo Han Guo extract, a polyol, and a mixture thereof;
a preservative; and
an acid.

24. The composition of claim 23, wherein the weight ratio between the sucralose and the second sweetener is from about 1:2 to about 1:40.

25. The composition of claim 23, wherein the preservative is potassium sorbate, sodium sorbate, sodium benzoate, potassium benzoate, methyl gallate, propyl gallate, sodium ethylenediaminetetraacetate, methyl paraben, propyl paraben, or a mixture thereof.

26. The composition of claim 23, wherein the acid is citric acid, succinic acid, lactic acid, propionic acid, tartaric acid, tannic acid, phosphoric acid, adipic acid, malic acid, acetic acid, gluconic acid, ascorbic acid, or a mixture thereof.

27. The composition of claim 23, further comprising a solvent selected from the group consisting of water, ethanol, glycerin, a polyethylene glycol, a polysorbate, and a mixture thereof.

28. The composition of claim 27, wherein the solvent is about 70% to about 99.5% of the total weight of the composition.

29. The composition of claim 23, wherein the sucralose is about 0.5% to about 5% of the total weight of the composition.

30. The composition of claim 23, wherein the second sweetener is about 10% to about 20% of the total weight of the composition.

31. The composition of claim 23, wherein the preservative is about 0.01% to about 3% of the total weight of the composition.

32. The composition of claim 23, wherein the acid is about 0.01% to about 3% of the total weight of the composition.

33. The composition of claim 23, wherein the composition has a pH at most about 5.

34. The composition of claim 23, wherein the composition has a pH at most about 4.

35. The composition of claim 23, wherein the composition has a pH at least about 3.

36. A composition, comprising:
a sweetener;
a preservative; and
succinic acid.

37. The composition of claim 36, further comprising a second acid selected from the group consisting of citric acid, lactic acid, propionic acid, tartaric acid, tannic acid, phosphoric acid, adipic acid, malic acid, acetic acid, gluconic acid, ascorbic acid, and a mixture thereof.

38. The composition of claim 37, wherein the weight ratio between the succinic acid and the second acid is from about 1:2 to about 2:1.

39. The composition of claim 36, wherein the sweetener is sucralose, acesulfame potassium, saccharin, aspartame, a stevia extract, neotame, cyclamate, a Luo Han Guo extract, a polyol, or a mixture thereof.

40. The composition of claim 36, wherein the preservative is potassium sorbate, sodium sorbate, sodium benzoate, potassium benzoate, methyl gallate, propyl gallate, sodium ethylenediaminetetraacetate, methyl paraben, propyl paraben, or a mixture thereof.

41. The composition of claim 36, further comprising a solvent selected from the group consisting of water, ethanol, glycerin, a polyethylene glycol, a polysorbate, and a mixture thereof.

42. The composition of claim 41, wherein the solvent is about 70% to about 99.5% of the total weight of the composition.

43. The composition of claim 36, wherein the sweetener is about 0.5% to about 30% of the total weight of the composition.

44. The composition of claim 36, wherein the preservative is about 0.01% to about 3% of the total weight of the composition.

45. The composition of claim 36, wherein the succinic acid is about 0.01% to about 3% of the total weight of the composition.

46. The composition of claim 36, wherein the composition has a pH at most about 5.

47. The composition of claim 36, wherein the composition has a pH at most about 4.

48. The composition of claim 36, wherein the composition has a pH at least about 3.

49. A composition, comprising:
sucralose;
a preservative selected from the group consisting of potassium sorbate, sodium sorbate, sodium benzoate, potassium benzoate, methyl gallate, propyl gallate, sodium ethylenediaminetetraacetate, methyl paraben, propyl paraben, and a mixture thereof;
first acid selected from the group consisting of citric acid, succinic acid, lactic acid, propionic acid, tartaric acid, tannic acid, phosphoric acid, adipic acid, malic acid, acetic acid, gluconic acid, ascorbic acid, and a mixture thereof; and
a second acid different from the first acid, the second acid being selected from the group consisting of citric acid, succinic acid, lactic acid, propionic acid, tartaric acid, tannic acid, phosphoric acid, adipic acid, malic acid, acetic acid, gluconic acid, ascorbic acid, and a mixture thereof.
